(19) United States
(12) Patent Application Publication
(10) Pub. No.: US 2026/0235939 A1
(43) Pub. Date: Aug. 13, 2026

(54) Camera Strap Attachment Mechanism

(71) Applicant: PGYTECH CO.,LTD, Jiangsu (CN)

(72) Inventors: Bingchao XIA, Jiangsu (CN); Shilei ZHU, Jiangsu (CN)

(73) Assignee: PGYTECH CO.,LTD, Jiangsu (CN)

(21) Appl. No.: 19/533,396

(22) Filed: Feb. 9, 2026

(30) Foreign Application Priority Data
Feb. 11, 2025 (CN) 202520211096X

(51) Int. Cl. G03B 17/56

(52) U.S. Cl. CPC G03B 17/566

(57) ABSTRACT

The present disclosure relates to a camera strap attachment mechanism, comprising an attachment assembly, which is formed with an assembly cavity; the upper and lower ends of the assembly cavity are respectively assembled with a camera strap and photographic equipment. A linkage component is provided inside the assembly cavity, and when subjected to a force, the linkage component generates a locking force acting on the camera strap, enabling the assembly cavity to move along the camera strap. The present disclosure not only accomplishes the assembly of the camera strap and photographic equipment through a single assembly cavity but also enables adjustments within the assembly cavity of the camera strap. Furthermore, by utilizing the linkage component, the assembly cavity can be locked and unlocked at different positions along the camera strap, facilitating user operation.

### CROSS-REFERENCE TO RELATED APPLICATIONS

This application claims priority to Chinese Disclosure Patent Application No. 202520211096.X, titled " Camera Strap Attachment Mechanism," filed on February 11, 2025, the content of which, including the amendments thereof, is incorporated herein by reference in its entirety.

### TECHNICAL FIELD

The present disclosure relates to the technical field of camera strap attachments in camera assembly, particularly to a camera strap attachment mechanism.

### BACKGROUND

In the prior art, a camera strap and a camera (or other photographic equipment) are typically connected and supported through an intermediate connector arranged between them. Such solutions generally involve separately assembling the camera strap to the intermediate connector and the intermediate connector to the camera: the camera strap is mostly a flexible band-like component, which is only passed through the intermediate connector by means of perforations, slots, or winding to form a hanging connection, relying primarily on friction or the strap’s own folding to maintain positional stability. Since the structural design of the intermediate connector focuses on achieving connection and load-bearing, its engagement with the strap is usually in a "freely passable" threaded state, making it difficult to simultaneously clamp or lock the strap at the connector. This results in the strap being prone to relative sliding at the connector during use, leading to increased shifting and swinging of the camera against the user’s body, affecting carrying comfort and shooting stability. To meet demands such as strap length adjustment and positional fixation in different usage scenarios, the prior art often requires additional independent locking mechanisms, clamping structures, or anti-slip components to lock or limit the strap. However, adding such locks not only increases the number of parts and assembly steps, raising manufacturing costs and structural complexity, but may also introduce issues like increased volume, more operational steps, and accidental loosening. Consequently, the intermediate connector functionally serves only a single connecting role, making it difficult to achieve integrated control of connection and locking, leaving room for further improvement in the overall user experience.

### SUMMARY

The present disclosure provides a camera strap attachment mechanism to address the issues raised in the background art.

To achieve the above object, the present disclosure adopts the following technical solution:

A camera strap attachment mechanism includes an attachment assembly, wherein an assembly cavity formed on the attachment assembly, and a camera strap and photographic equipment are respectively assembled at upper and lower ends of the assembly cavity; and a linkage component provided inside the assembly cavity, wherein the linkage component, when subjected to a force, generates a locking force acting on the camera strap, enabling the assembly cavity to move along the camera strap.

The present disclosure further provides a camera strap attachment mechanism, including: an attachment assembly, wherein an assembly cavity is formed on the attachment assembly, and a camera strap and photographic equipment are respectively assembled at upper and lower ends of the assembly cavity; and a linkage component provided in the assembly cavity, wherein the linkage component, when subjected to a force, generates a locking force acting on the camera strap, enabling the assembly cavity to move along the camera strap. The assembly cavity is vertically arranged in a penetrating manner, with an upper end forming a clamping cavity for the camera strap to pass through, and a lower end thereof forming a locking cavity for fastening and locking the photographic equipment; and the linkage component is located in the assembly cavity adjacent to the clamping cavity, and when driven to move, the linkage component switches the camera strap in the clamping cavity between a released state and a clamped state; and in the released state, the attachment assembly is allowed to be adjusted by sliding relative to the camera strap, while in the clamped state, the attachment assembly relative to the camera strap is restricted from sliding, reducing swing and displacement of the photographic equipment during use.

The beneficial effects of the present disclosure compared to the prior art are as follows:

First, the present disclosure utilizes the assembly cavity to assemble the photographic equipment and camera strap through its two ends respectively, not only ensuring the connection between the photographic equipment and camera strap but also requiring only one attachment assembly, thereby saving on the number of assembly tools.

Second, by adding a linkage component within the assembly cavity, controlling the linkage component can generate a locking force on the camera strap, enabling the camera strap to have the possibility of unlocking and locking directly at the assembly cavity, thereby enhancing and perfecting the functionality of the attachment assembly.

Finally, since the assembly cavity can move along the camera strap, different positions of the camera strap can be located within the assembly cavity through this method. Thus, after adjustments such as the length of the camera strap, the locking position of the camera strap can be adjusted as needed.

### BRIEF DESCRIPTION OF DRAWINGS

The drawings, which form a part of this application, are provided to further illustrate the present disclosure. The illustrative embodiments and descriptions of the present disclosure are used to explain the present disclosure and do not constitute an improper limitation thereof. In the drawings:

FIG. 1 is a front view of a camera strap in a locked state in a camera strap attachment mechanism provided by the present disclosure;

FIG. 2 is one of the cross-sectional views of a camera strap in a locked state in a camera strap attachment mechanism provided by the present disclosure;

FIG. 3 is a second cross-sectional view showing the locked state of the camera strap in a camera strap attachment mechanism provided by the present disclosure;

FIG. 4 is a front view showing the unlocked state of the camera strap in a camera strap attachment mechanism provided by the present disclosure;

FIG. 5 is a first cross-sectional view showing the unlocked state of the camera strap in a camera strap attachment mechanism provided by the present disclosure;

FIG. 6 is a second cross-sectional view showing the unlocked state of the camera strap in a camera strap attachment mechanism provided by the present disclosure;

FIG. 7 is a first usage state diagram showing strap adjustment being performed by a camera strap attachment mechanism provided by the present disclosure;

FIG. 8 is a second usage state diagram showing strap adjustment being performed by a camera strap attachment mechanism provided by the present disclosure;

FIG. 9 is a first structural schematic diagram of a driving mechanism composed of a cam provided by the present disclosure;

FIG. 10 is a second structural schematic diagram of a driving mechanism composed of a cam provided by the present disclosure;

FIG. 11 is a first structural schematic diagram of another driving mechanism composed of a cam provided by the present disclosure;

FIG. 12 is a second structural schematic diagram of another driving mechanism composed of a cam provided by the present disclosure;

FIG. 13 is a first structural schematic diagram of a driving mechanism composed of a scissor-type structure provided by the present disclosure;

FIG. 14 is a second structural schematic diagram of a driving mechanism composed of a scissor-type structure provided by the present disclosure; and

FIG. 15 is a structural schematic diagram of a lock button provided by the present disclosure;

Reference signs: 1, Attachment Assembly; 1-1, Clamping Cavity; 1-2, Locking Cavity; 1-3, Unlock Button; 1-4, Lock Button; 1-5, Slot; 2, Camera Strap; 3, Photographic Equipment; 4, Linkage Component; 5, Driving Mechanism; 5-1, Cam; 5-2, Scissor-Type Lifting Structure; 6, Pin; 7, Fastener; 8, Connector.

### DESCRIPTION OF EMBODIMENTS

The technical solutions in the embodiments of the present disclosure will be clearly and completely described below with reference to the accompanying drawings in the embodiments of the present disclosure. It is obvious that the described embodiments are only a part of the embodiments of the present disclosure, rather than all of them. The following description of at least one exemplary embodiment is illustrative in nature and is in no way intended to limit the present disclosure, its application, or use. All other embodiments obtained by a person of ordinary skill in the art based on the embodiments of the present disclosure without creative efforts shall fall within the protection scope of the present disclosure.

It should be noted that the terms used herein are only for describing specific embodiments and are not intended to limit the exemplary embodiments according to the present application. As used herein, unless the context clearly indicates otherwise, the singular forms are intended to include the plural forms as well. Furthermore, it should be appreciated that when the terms "include" and/or "include" are used in this specification, they indicate the presence of features, steps, operations, devices, components, and/or combinations thereof.

Unless specifically stated otherwise, the relative arrangement, numerical expressions, and numerical values of components and steps set forth in these embodiments do not limit the scope of the present disclosure. At the same time, it should be appreciated that, for ease of description, the dimensions of various parts shown in the drawings are not drawn according to actual proportional relationships. Techniques, methods, and devices known to those of ordinary skill in the relevant art may not be discussed in detail, but where appropriate, such techniques, methods, and devices should be considered part of the authorized specification. In all examples shown and discussed herein, any specific values should be interpreted as illustrative only and not as limiting. Therefore, other examples of the exemplary embodiments may have different values. It should be noted that similar reference numerals and letters denote similar items in the following drawings, so once an item is defined in one drawing, it does not require further discussion in subsequent drawings.

In the present disclosure, addressing the technical problem in the prior art where camera straps are typically only attached to intermediate connectors by threading, making it difficult to achieve effective clamping and locking at the connection point, prone to slippage during use that would cause swing and displacement of the equipment, and often requiring additional buckle structures that increase complexity, a camera strap attachment mechanism is provided. By incorporating a linkage component and its driving structure within the through assembly cavity of the attachment assembly, the strap can switch between "adjustable sliding" and "stable locking" at the clamping cavity, while the equipment is reliably connected at the locking cavity, thereby integrating connection and locking functions and enhancing wearing stability. The specific embodiments of the present disclosure are described in detail below with reference to the accompanying drawings.

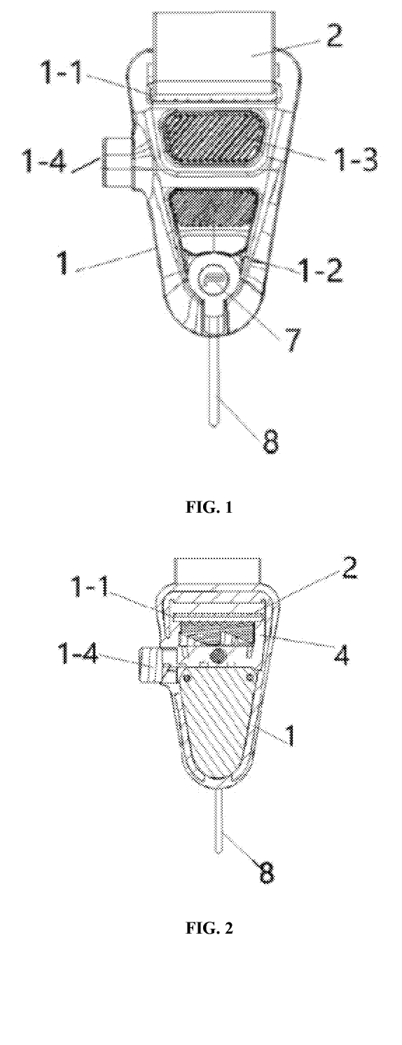

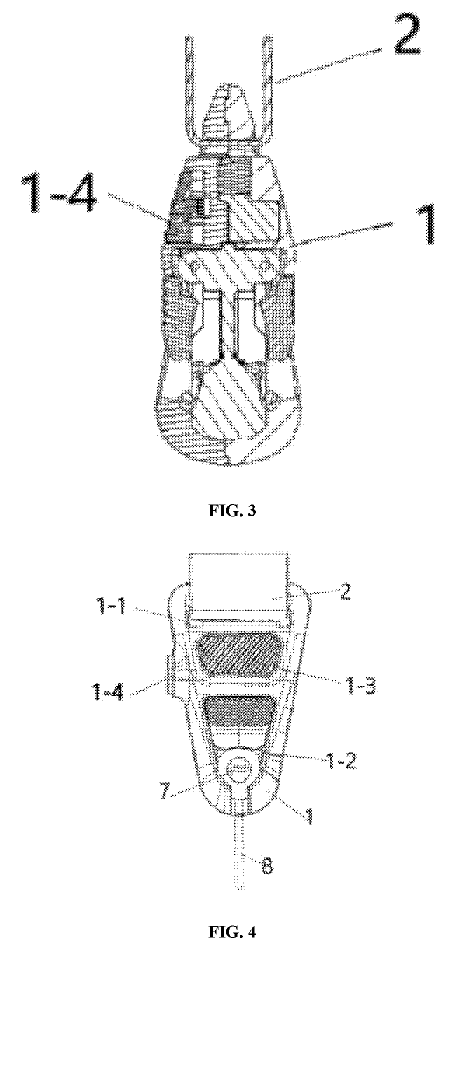

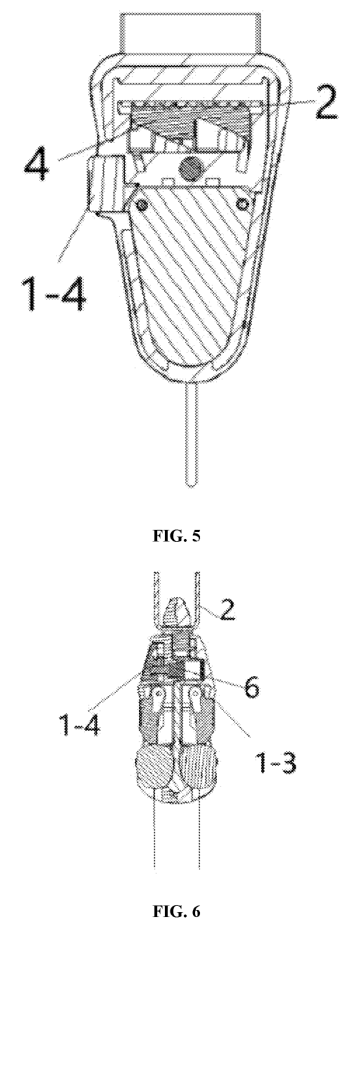

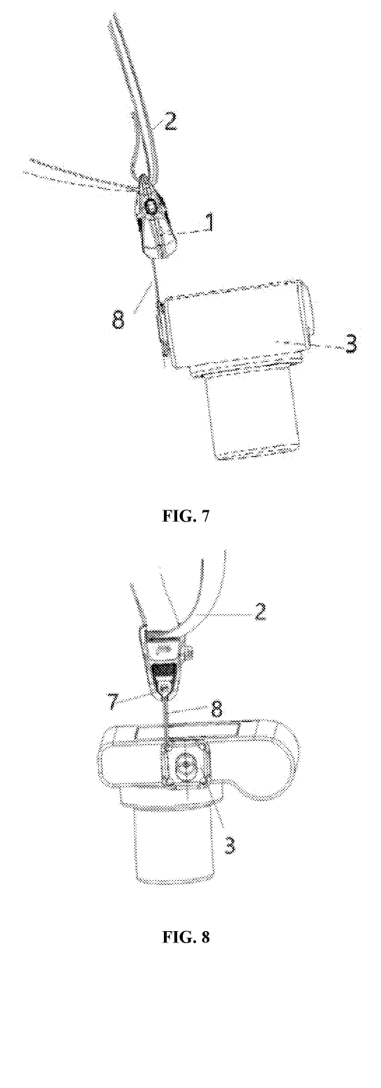

As shown in FIGS. 1-8, a camera strap attachment mechanism in this embodiment includes an attachment assembly 1. The attachment assembly 1 is an integrally formed or assembled attachment body formed from several components, featuring an assembly cavity that runs through vertically. The upper and lower ends of the assembly cavity are respectively equipped with a camera strap 2 and photographic equipment 3. Here, the camera strap 2 is preferably a band-shaped flexible member threaded through the upper end of the assembly cavity, while the photographic equipment 3 is positioned at the lower end of the assembly cavity and is relatively fixed to the attachment assembly 1 through a connection structure, thereby achieving integrated assembly and carrying of the camera strap 2 and the photographic equipment 3. A linkage component 4 is provided inside the assembly cavity. When force is applied, the linkage component 4 generates a locking force acting on the camera strap 2, allowing the assembly cavity to move along the camera strap 2. When the locking force increases, it can restrict slippage of the assembly cavity relative to the camera strap 2, meeting stability requirements during use.

In other embodiments (not shown), besides being integrally formed, the attachment assembly 1 can also be assembled using a split-shell structure (such as an upper/lower shell or left-right mating shells). The shells can be fixed together through screws, snaps, rivets, or ultrasonic welding. Here, the assembly cavity can be correspondingly configured as a rounded rectangular cavity, a T-shaped guide cavity, or a slide cavity with rails to provide more stable linear guidance for the linkage component 4 and reduce the risk of jamming, thereby improving the consistency and durability of the locking/unlocking actions.

In this embodiment, during use, the user typically hangs the camera strap 2 directly on the body, and the photographic equipment 3 naturally hangs downward due to its weight. Consequently, the two are respectively arranged at the two ends of the assembly cavity, allowing them to be assembled in a more reasonable manner and achieving integrated attachment assembly of the camera strap 2 and the photographic equipment 3. By positioning the camera strap 2 and the photographic equipment 3 at the upper and lower ends of the assembly cavity, it not only conforms to the direction of gravity for natural hanging of the equipment but also clarifies the force path of the camera strap 2, resulting in better force distribution and wearing experience during walking, lifting, or adjusting posture.

In this embodiment, a linkage component 4 is arranged within the assembly cavity. Compared to a simple pass-through assembly, the linkage component 4 enables the locking of the camera strap 2 inside the attachment assembly 1, making the entire attachment more complete. Simultaneously, the simple pass-through assembly, now enhanced with locking, can prevent the camera strap 2 from sliding at the assembly cavity. During use, the photographic equipment 3 located at the bottom of the assembly cavity will also have a relatively fixed position, thereby reducing the sliding of the photographic equipment 3 on the user’s body caused by the sliding of the camera strap 2 within the assembly cavity. By directly generating a controllable locking force on the camera strap 2 inside the assembly cavity, the relative displacement between the camera strap 2 and the attachment assembly 1 can be reduced, consequently minimizing the swing and shifting of the photographic equipment 3 on the user’s body surface, improving wearing stability and operational comfort.

In this embodiment, the addition of the linkage component 4 makes the simple attachment assembly 1 more functionally diverse, while reducing the need for separate locking mechanisms related to the camera strap 2, thereby enhancing the user experience.

Specifically, referring to the accompanying drawings, it can be seen that in this embodiment, a clamping cavity 1-1 and a locking cavity 1-2 are respectively formed at the upper and lower ends of the assembly cavity. The clamping cavity 1-1 is located at the upper end of the assembly cavity and is used for the threading and clamping of the camera strap 2. The locking cavity 1-2 is located at the lower end of the assembly cavity and is used for the fastening and locking of the photographic equipment 3. After the camera strap 2 passes through the clamping cavity 1-1, the movement of the linkage component 4 causes the camera strap 2 at the entry point of the clamping cavity 1-1 to be clamped or released, achieving a clamped state or released state at this location, thereby allowing the attachment assembly 1 to switch between "adjustable movement" and "stable locking." Typically, the released state is used for storage before use, while the clamped state is more suitable during use to prevent the camera strap 2 from shifting; as for the locking cavity 1-2, the photographic equipment 3 is simply assembled normally, allowing the user to carry the camera strap 2 with the photographic equipment 3 on their body for easy portability.

In this embodiment, for the linkage component 4, it can be arranged at a position of the assembly cavity adjacent to the clamping cavity 1-1, so that the linkage component 4 directly applies a clamping effect on the strap segment at the clamping cavity 1-1. At this time, it only needs to satisfy that the linkage component 4 is moved close to or away from the locking cavity 2, causing the clamping gap formed by the clamping cavity 1-1 to enlarge or shrink. If the gap enlarges, the camera strap 2 and the clamping cavity 1-1 can move; if the gap shrinks, the camera strap 2 is fixed and cannot move. In this process, a driving mechanism is generally required to drive the related control.

Firstly, regarding the motion control of the linkage component 4 in this embodiment, the specifics are introduced as follows:

As shown in the accompanying drawings, in order to drive the linkage component 4 to generate locking force, a driving mechanism 5 acting on the linkage component 4 and performing a linear reciprocating motion or rotational reciprocating motion within the assembly cavity is also included. The motion of the driving mechanism 5 causes the linkage component 4 to perform a linear reciprocating motion. In this reciprocating motion, the linkage component 4 forms a regular movement, and this regularity brings about a tendency to increase or decrease the locking force, thereby completing locking or unlocking during this process. Here, the motion method of the driving mechanism 5 within the assembly cavity is not limited to one type, allowing users to choose different driving mechanism motion methods based on factors such as cost and space. Thus, the linkage component 4 can switch between a locking position and an unlocking position under the action of the driving mechanism 5, achieving adjustment of the clamping force on the strap segment and output of the locking force.

In the above motion, since the clamping cavity 1-1 is located at the top of the assembly cavity, the linkage component 4 needs to perform vertical linear reciprocating motion to adjust the size of the clamping cavity 1-1. Consequently, regardless of whether the driving mechanism 5 is linear or rotational, it drives the strap pressing surface 4-1 on the linkage component 4 to press against or release the camera strap 2, enabling the camera strap 2 at the clamping cavity 1-1 to switch between a "slidable or non-slidable" state. Here, the strap pressing surface 4-1 can be composed of several serrated structures. Compared to a flat surface directly generating pressing force, the serrated structure creates greater friction, resulting in a more secure locking force, thereby further reducing the risk of accidental slippage of the camera strap 2 at the assembly cavity during use.

In other embodiments (not shown), besides the clamping gap structure through which the camera strap 2 passes, the clamping cavity 1-1 may also be equipped with guide rollers, limit shoulders, or replaceable padding components (such as rubber pads, silicone pads, or wear-resistant fabric pads) to accommodate strap belts of different widths/thicknesses; among these, the strap pressing surface 4-1 of the linkage component 4, in addition to the serrated structure, can also be a knurled surface, corrugated surface, or rubber-coated friction surface, or adopt a composite pressing surface structure of "rigid pressing block + elastic layer" to ensure locking force while reducing wear on the strap surface.

In other embodiments (not shown), the housing of the attachment assembly 1 may feature anti-slip textures, weight-reducing hollow ribs, or a soft rubber coating to enhance grip and operational stability; among these, the material of the attachment assembly 1 is preferably metal or plastic, and besides, a composite structure combining a metal frame with an engineering plastic housing can be used, or materials such as wear-resistant reinforced nylon, aluminum alloy, or titanium alloy may be employed to optimize the balance between strength, weight, and aesthetic texture.

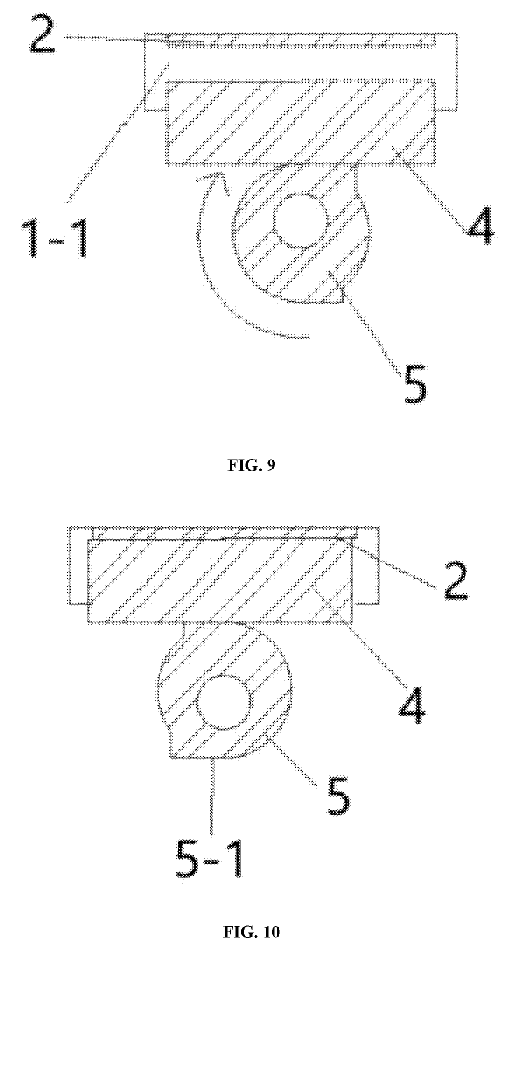

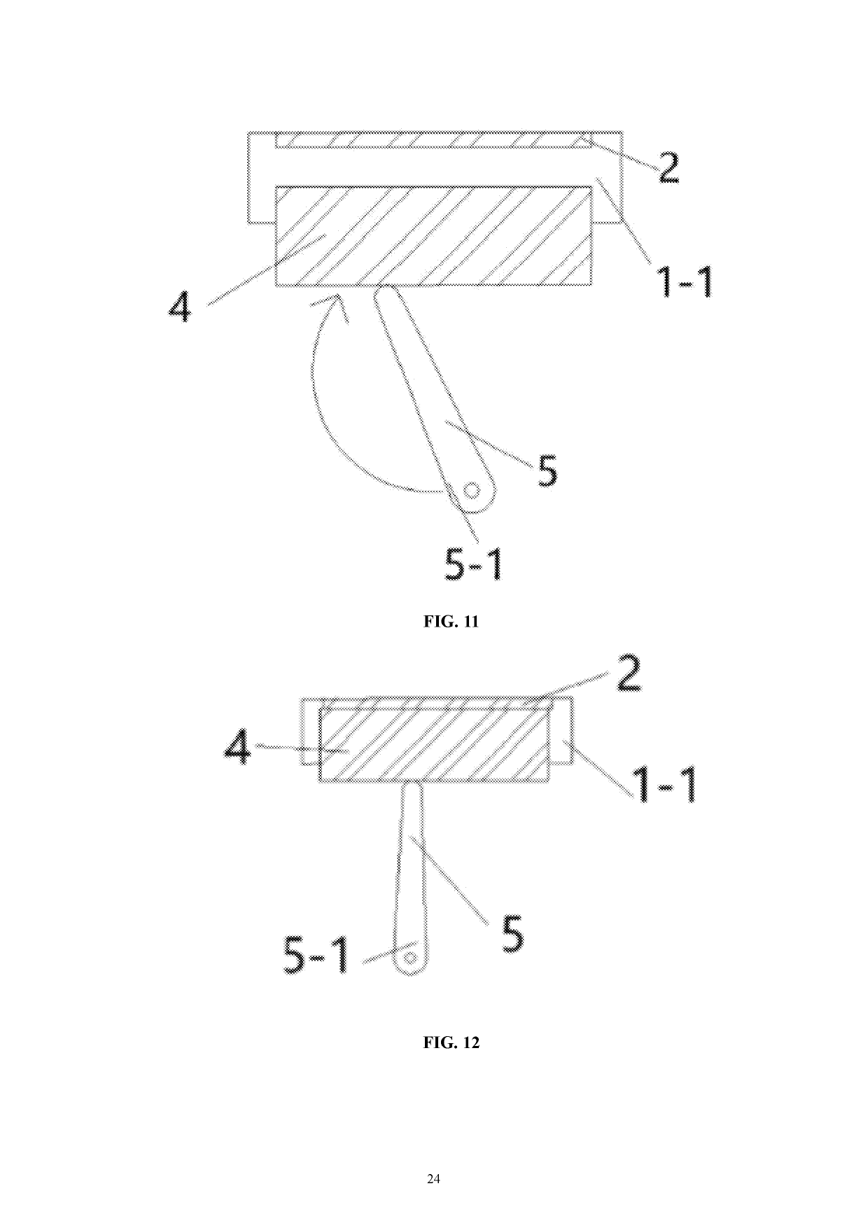

Referring to FIGS. 9-14, in the present disclosure, the driving mechanism 5 can be one of a linear push rod, a cam, or a scissor-type lifting structure.

In an embodiment of the present disclosure, for the driving mechanism 5 formed by a linear push rod, the linear push rod is directly placed in the assembly cavity, with its top fixedly connected to the linkage component 4; then, under the action of a motor or similar, it drives the linkage component 4 to move up and down, thereby adjusting the position of the clamping cavity 1-1.

In another embodiment of the present disclosure, the cam method is chosen; here, referring to FIGS. 11-12, the top of the cam 5-1 contacts the linkage component 4, and during the rotation of the cam 5-1, different positions will come into contact with the linkage component 4; during forward rotation, the linkage component 4 rises, while reverse rotation allows it to descend. In the assembly cavity, the rotation of the cam 5-1 can be axial or radial. The cam here can also be replaced by a rotating rod.

Certainly, referring to FIGS. 11-12, the end of the cam 5-1 can be hinged at the bottom of the linkage component 4; then, directly or indirectly rotating the cam 5-1 will generate a force on the linkage component 4 during its rotation, causing it to press against or move away from the camera strap 2, thereby adjusting the clamping space within the clamping cavity 1-1.

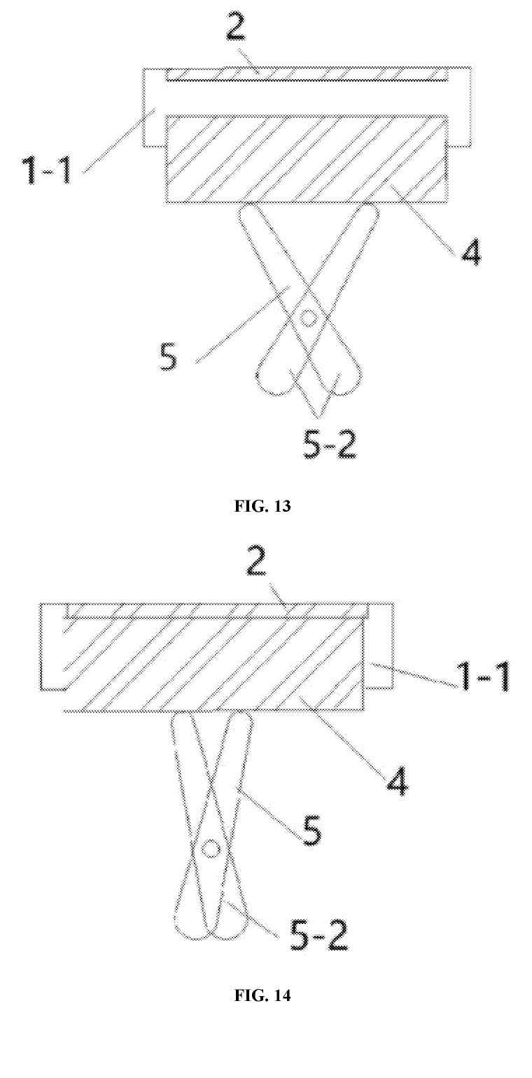

In yet another embodiment of the present disclosure, referring to FIGS. 13-14, a scissor-type lifting structure 5-2 may be selected. During the closing or opening of the scissors, it drives the linkage component 4 to lift. Through any of the above driving implementation methods, adaptation and selection can be made among structural volume, cost, and operation method, thereby improving the feasibility and applicability of the solution.

In other embodiments (not shown), in addition to the linear push rod, cam 5-1, or scissor-type lifting structure 5-2, the driving mechanism 5 may also adopt a knob screw, rack and pinion, lever-type ratchet, or slider-pick structure to drive the linkage component 4 in reciprocating motion; among these, the unlock button 1-3 and lock button 1-4 can be replaced with a single pick-type switch, rotary dial, or push-pull slide knob, and can be combined with the pin 6 to form a ball detent, spring tab stop, or pawl anti-reverse structure, to reduce the number of components and enhance blind-operation reliability.

Secondly, regarding the linkage component 4 in the preferred embodiment of the present disclosure, its specific introduction is as follows:

In this embodiment, to achieve locking of the camera strap 2 located in the clamping cavity 1-1 while assembling within the assembly cavity, the linkage component 4 is in a wedge-shaped structure, which generates a pressing force acting on the camera strap 2. The wedge-shaped structure enables the linkage component 4 to effectively convert displacement into clamping force output on the camera strap 2 during movement, thereby forming and enhancing the locking force. In this embodiment, the bottom of the wedge-shaped structure forms a certain inclined surface. During subsequent linear or rotational motion of the driving mechanism 5, contact is made at different heights of the inclined surface to apply and adjust the locking force. The bottom of the inclined surface may form the trigger part of the wedge-shaped structure, which then directly interlinks with the driving mechanism 5. When the driving mechanism 5 rotates or moves linearly to the set position, the driving mechanism 5 and linkage component 4 begin to interlink, at which point the trigger part starts to generate the locking force. The set position here specifically refers to the locked position or unlocked position.

In other embodiments (not shown), besides a single pressing component, the linkage component 4 may also adopt a bilateral clamping structure, i.e., setting a first pressing component and a second pressing component on both sides of the clamping cavity 1-1 respectively, and synchronizing them through the same driving mechanism 5, making the force on the strap 2 more uniform and the locking more reliable; among these, the two pressing components may use symmetrical wedges, swing arm grippers, or parallel clamping block structures to adapt to wider or thicker straps 2.

To facilitate control of the linkage component 4, a preferred embodiment of the present disclosure further includes a control button for applying a forward force or reverse force to the linkage component 4. That is, referring to the unlock button 1-3 and lock button 1-4 in FIGS. 1-6, the user can unlock or lock the camera strap 2 in the clamping cavity 1-1 through different buttons, with the unlock button 1-3 and lock button 1-4 effectively constituting the driving mechanism 5.

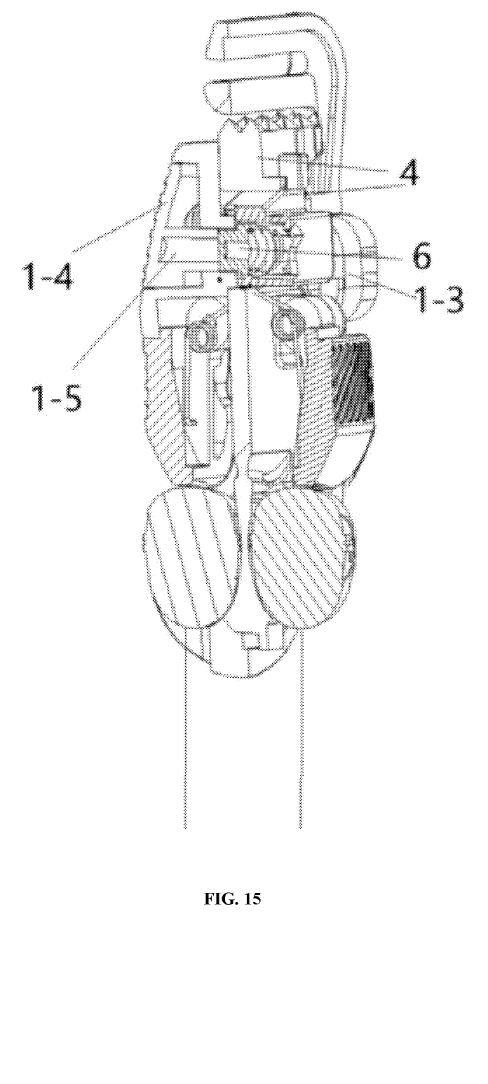

As shown in FIG. 15, in practical use, the unlock button 1-3 is positioned on the front side, while the lock button 1-4 is located on the side. The lock button 1-4 contains a spring pin; when pressed, it moves inward toward the assembly cavity, causing the pin 6 inside the spring to be pushed into the slot 1-5 of the unlock button 1-3. Simultaneously, the housing of the lock button 1-4 contacts the wedge at the bottom of the linkage component 4, driving it upward. This not only restricts downward movement of the camera strap 2 but also enables the camera strap 2 to be locked within the assembly cavity. When the unlock button 1-3 is pressed, the movement of the slot 1-5 drives the pin 6 to move backward inside the assembly housing. This causes the compression spring outside the pin 6 to be stressed, inducing a certain twist in the pin 6, similar to a torsion spring, thereby disengaging the pin 6 from the housing of the unlock button 1-3. Then, the force exerted by the unlock button 1-3 on the spring disappears, allowing the spring to reset outward. The lock button 1-4 retracts, and its force on the linkage component 4 ceases, completing the unlocking.

In other embodiments (not shown), the unlock button 1-3 and lock button 1-4 may incorporate anti-misoperation features, such as button guards, recessed button cavities, sliding protective covers, or dual-action triggering mechanisms (press + slide), to reduce the risk of accidental unlocking during carrying. Furthermore, the button travel can be designed with staged damping or a two-stage tactile feel to make locking/unlocking actions clearer and more reliable.

Finally, the assembly of the photographic equipment 3 is described as follows:

As shown in the figures, the photographic equipment 3 is specifically assembled through a fastener 7, which is detachably mounted in the locking cavity 1-2 at the bottom of the assembly cavity.

In this embodiment, one end of the fastener 7 is movably connected to the assembly cavity through the locking cavity 1-2, while the other end is connected to the photographic equipment 3 through a connector 8.

In this embodiment, regarding the locking of the fastener 7 within the locking cavity 1-2 and its connection to the photographic equipment 3, reference can be made to the solution in the prior art with publication number CN 215075921U. Here, the locking cavity 1-2 corresponds to the locking cavity in the prior art, the fastener 7 corresponds to the fastener body in the prior art, and the photographic equipment in this embodiment corresponds to the strap connected to the connector in the prior art. Then, a rope structure or connecting rod can be selected to form the connector, directly connecting the photographic equipment to the connector. In this way, the fastener 7 can be locked or unlocked in the locking cavity 1-2, enhancing connection stability.

In other embodiments (not shown), besides accommodating the fastener 7, the locking cavity 1-2 can also be adapted for quick-release plug-in buckles, carabiners/swivel rings, magnetic quick-release buckles, or safety spring latch structures. Furthermore, besides ropes or connecting rods, the connector 8 can also adopt webbing loops, wire rope sheath structures, or flexible loop structures to meet the load-bearing, vibration damping, and weather resistance requirements of different photographic equipment 3.

In this disclosure, through simple structural improvements, the assembly cavity on the attachment assembly not only enables direct assembly of the camera strap and photographic equipment through the same structure but also allows operations such as locking the camera strap through locking force through the linkage component within the assembly cavity. Additionally, through the movement of the assembly cavity, camera straps at different positions can be locked within the assembly cavity. Therefore, without the need for additional independent locking mechanisms, it achieves both adjustable strap positioning and stable locking during use, effectively reducing slippage and swing during carrying, walking, and handling of equipment, thereby improving overall reliability and user experience.

In the description of the present disclosure, it should be appreciated that directional terms such as "front, rear, up, down, left, right," "traverse, vertical, perpendicular, horizontal," and "top, bottom" generally indicate orientations or positional relationships based on those shown in the accompanying drawings. They are used merely for convenience in describing the present disclosure and simplifying the description; unless stated otherwise, these terms do not indicate or imply that the referred device or component must have a specific orientation or be constructed and operated in a specific orientation, and thus should not be construed as limiting the scope of protection of the present disclosure. The directional terms "inner, outer" refer to the inside and outside relative to the contour of each component itself.

For ease of description, spatial relative terms such as "on," "above," "on the upper surface," "upper," may be used here to describe the spatial positional relationship of one device or feature to other devices or features as illustrated in the figures. It should be appreciated that the spatial relative terms are intended to encompass different orientations of the device in use or operation, in addition to the orientation depicted in the figures. For example, if a device in the drawings is inverted, a device described as "above other devices or structures" or "on other devices or structures" would then be oriented as "below other devices or structures" or "under other devices or structures." Thus, the exemplary term "above" can encompass both "above" and "below" orientations. The device may also be oriented in other ways (rotated 90 degrees or at other orientations), and the spatial relative descriptions used herein should be interpreted accordingly.

Furthermore, the use of terms such as "first," "second," to define components is for the purpose of distinguishing the corresponding components. Unless otherwise stated, these terms do not have special meanings and should not be construed as limiting the scope of protection of the present disclosure.

The above descriptions are merely preferred embodiments of the present disclosure and are not intended to limit the present disclosure. For those skilled in the art, various modifications and changes can be made to the present disclosure. Any modifications, equivalent substitutions and improvements made within the spirit and principles of the present disclosure shall be included within the scope of protection of the present disclosure.

What is claimed is:

1. A camera strap attachment mechanism, comprising,
an attachment assembly, wherein an assembly cavity formed on the attachment assembly, and a camera strap and photographic equipment are respectively assembled at upper and lower ends of the assembly cavity; and
a linkage component provided inside the assembly cavity, wherein the linkage component, when subjected to a force, generates a locking force acting on the camera strap, enabling the assembly cavity to move along the camera strap.

2. The camera strap attachment mechanism according to claim 1, further comprising a driving mechanism acting on the linkage component and performing a linear reciprocating motion or rotational reciprocating motion within the assembly cavity, wherein the motion of the driving mechanism enables the linkage component to perform a linear reciprocating motion.

3. The camera strap attachment mechanism according to claim 2, wherein during the linear reciprocating motion of the linkage component, a strap pressing surface on the linkage component presses against or releases the camera strap.

4. The camera strap attachment mechanism according to claim 3, wherein the driving mechanism comprises a linear push rod, a cam, or a scissor-type lifting structure.

5. The camera strap attachment mechanism according to claim 2, wherein the linkage component has a wedge-shaped structure configured to generate a pressing force acting on the camera strap.

6. The camera strap attachment mechanism according to claim 5, wherein a trigger part linked with the driving mechanism is provided at a bottom of the wedge-shaped structure, and when the driving mechanism moves to a set position, the trigger part begins to generate a locking force.

7. The camera strap attachment mechanism according to claim 1, wherein a clamping cavity for the camera strap is formed at a top of the assembly cavity, and the motion of the linkage component enables the camera strap in the clamping cavity to be in a clamped state or a released state.

8. The camera strap attachment mechanism according to claim 1, further comprising a control button for applying a forward force or reverse force to the linkage component.

9. The camera strap attachment mechanism according to claim 1, wherein a locking cavity is formed at a bottom of the assembly cavity, and the photographic equipment is detachably assembled within the locking cavity through a fastener.

10. The camera strap attachment mechanism according to claim 9, wherein one end of the fastener is movably connected to the assembly cavity through the locking cavity, and the other end is connected to the photographic equipment through a connector.

11. A camera strap attachment mechanism, comprising:
an attachment assembly, wherein an assembly cavity is formed on the attachment assembly, and a camera strap and photographic equipment are respectively assembled at upper and lower ends of the assembly cavity; and
a linkage component provided in the assembly cavity, wherein the linkage component, when subjected to a force, generates a locking force acting on the camera strap, enabling the assembly cavity to move along the camera strap;
wherein the assembly cavity is vertically arranged in a penetrating manner, with an upper end forming a clamping cavity for the camera strap to pass through, and a lower end thereof forming a locking cavity for fastening and locking the photographic equipment; and
the linkage component is located in the assembly cavity adjacent to the clamping cavity, and when driven to move, the linkage component switches the camera strap in the clamping cavity between a released state and a clamped state; and
in the released state, the attachment assembly is allowed to be adjusted by sliding relative to the camera strap, while in the clamped state, the attachment assembly relative to the camera strap is restricted from sliding, reducing swing and displacement of the photographic equipment during use.

12. The camera strap attachment mechanism according to claim 11, by further comprising a driving mechanism acting on the linkage component and located in the assembly cavity, wherein the assembly cavity performs a linear reciprocating or rotational reciprocating motion within the assembly cavity to drive the linkage component to move.

13. The camera strap attachment mechanism according to claim 12, wherein the movement of the driving mechanism enables the linkage component to perform a linear reciprocating motion.

14. The camera strap attachment mechanism according to claim 11, wherein the linkage component has a strap pressing surface configured to press against the camera strap in the clamped state and release the camera strap in the released state.

15. The camera strap attachment mechanism according to claim 14, wherein the strap pressing surface is a serrated structure.

16. The camera strap attachment mechanism according to claim 12, wherein the linkage component is a wedge-shaped structure configured to generate a pressing force acting on the camera strap.

17. The camera strap attachment mechanism according to claim 16, wherein a trigger part linked with the driving mechanism is provided at a bottom of the wedge-shaped structure, and when the driving mechanism moves to a set position, the trigger part begins to generate a locking force.

18. The camera strap attachment mechanism according to claim 11, further comprising a control button for applying a forward force or reverse force to the linkage component, to achieve unlocking or locking of the camera strap within the clamping cavity.

19. The camera strap attachment mechanism according to claim 18, wherein the control button comprises an unlock button and a lock button, a spring pin is provided inside the lock button, and a slot is provided on the unlock button;
when the lock button is pressed, the spring pin enters the slot and causes the lock button to exert a force on the linkage component to move the linkage component toward the clamped state; and
when the unlock button is pressed, the lock button retracts to release the force on the linkage component, thereby completing the unlocking.

20. The camera strap attachment mechanism according to claim 11, wherein a fastener is detachably assembled in the locking cavity, one end of the fastener is movably connected to the assembly cavity through the locking cavity, and the other end of the fastener is connected to photographic equipment through a connector.
